(19) United States
(12) Patent Application Publication
(10) Pub. No.: US 2025/0313060 A1
(43) Pub. Date: Oct. 9, 2025

(54) PLASTIC DUCTS WITH OVER-MOLDED STEEL FLANGE FOR THERMAL INTERFACES

(71) Applicant: GM Global Technology Operations LLC, Detroit, MI (US)

(72) Inventors: Karthick P. Ghawalkar, Bangalore (IN); Bhaskara Kishore Chirravuri, Bangalore (IN); Abhishek Kumar Sahu, Bengaluru (IN)

(73) Assignee: GM Global Technology Operations LLC, Detroit, MI (US)

(21) Appl. No.: 18/627,404

(22) Filed: Apr. 4, 2024

(51) Int. Cl. B60H 1/00

(52) U.S. Cl. CPC B60H 1/00557

(57) ABSTRACT

A duct assembly includes a metallic flange having a first side and a second side opposite the first side. An opening is formed at the first side of the metallic flange. A plastic duct extends from the second side of the metallic flange. A passageway of the plastic duct is in fluid communication with the opening of the metallic flange. The first side of the metallic flange is configured to join to a metallic mounting surface of a vehicular component and the passageway of the plastic duct is in fluid communication with the vehicular component via the opening of the metallic flange when the duct assembly is mounted at the vehicular component.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to a seal formed between vehicular components that withstands thermal changes during operation of the components and/or transfer of material between the components. Specifically, the present disclosure provides a plastic duct integrally formed with a metallic flange for interfacing with a metallic mounting surface of a compressor, where the duct carries ambient air to the compressor. The compressor generates heat during operation and the metallic flange resists thermal transfer from the compressor to the plastic duct.

Vehicular components generate heat and often transfer this heat to other components or systems of the vehicle that are in thermal connection with the heat generating vehicular component, such as by carrying heated, ambient, or cooled fluid to and/or from the vehicular component. These vehicular components are often formed from a metallic material, while ducts and hoses connected to the vehicular components for carrying the fluid or gas to and/or from the components are often formed from a rubber or plastic material with reduced thermal resistance compared to the metallic material of the vehicular component. Traditionally, plastic ducts are joined to metallic vehicular components using elastomeric press-in-place (PIP) seals or other rubberized seals. Over the life of the system, prolonged heat exposure can degrade these rubberized seals and plastic ducts.

### SUMMARY

One aspect of the disclosure provides a duct assembly. The duct assembly includes a metallic flange having a first side, a second side opposite the first side, and an opening formed at the first side of the metallic flange. The duct assembly also includes a plastic duct extending from the second side of the metallic flange. The plastic duct includes a passageway that is in fluid communication with the opening of the metallic flange. The first side of the metallic flange is configured to join to a metallic mounting surface of a vehicular component and the passageway of the plastic duct is configured to be in fluid communication with the vehicular component via the opening of the metallic flange when the duct assembly is mounted at the vehicular component.

Implementations of the disclosure may include one or more of the following optional features. In some examples, the plastic duct is over-molded at the second side of the metallic flange. In further examples, the second side of the metallic flange includes an interlock surface. In other further examples, the duct assembly further includes a bonding agent disposed between the second side of the metallic flange and the plastic duct.

In some implementations, the duct assembly is configured to be secured at the vehicular component via a mechanical fastener extending through the metallic flange and received at the vehicular component. In further implementations, the plastic duct includes a flange portion extending along the second side of the metallic flange. The mechanical fastener extends through the metallic flange and the flange portion of the duct. In even further implementations, the metallic flange includes a compression limiter extending from the second side of the metallic flange and at least partially through the flange portion of the plastic duct. The mechanical fastener extends through the metallic flange and the flange portion of the plastic duct and along the compression limiter.

In some examples, the first side of the metallic flange is configured to engage a metallic gasket disposed between the first side of the metallic flange and the mounting surface of the vehicular component. In some aspects, the metallic flange is configured to join to the metallic mounting surface at one selected from the group consisting of (i) an inlet of the vehicular component and (ii) an outlet of the vehicular component. In some implementations, the vehicular component includes a compressor of a fuel cell system of a vehicle. The compressor generates heat during operation of the fuel cell system.

Another aspect of the disclosure provides a fuel cell system. The fuel cell system includes a component that generates heat during operation of the fuel cell system. The component includes a metallic mounting surface. The fuel cell system also includes a duct assembly. The duct assembly includes a metallic flange having a first side, a second side opposite the first side, and an opening formed at the first side of the metallic flange. The first side of the metallic flange is joined to the metallic mounting surface of the component. The duct assembly also includes a plastic duct over-molded at the second side of the metallic flange. The plastic duct includes a passageway that is in fluid communication with the component via the opening of the metallic flange.

Implementations of this aspect of the disclosure may include one or more of the following optional features. In some examples, the second side of the metallic flange includes an interlock surface.

In some implementations, the fuel cell system further includes a bonding agent disposed between the second side of the metallic flange and the plastic duct.

In some examples, the plastic duct includes a flange portion extending along the second side of the metallic flange, the metallic flange including a compression limiter extending from the second side of the metallic flange and at least partially through the flange portion of the plastic duct with a mechanical fastener extending through the metallic flange and the flange portion of the plastic duct and along the compression limiter. The mechanical fastener is received at the component to secure the duct assembly at the component.

In some aspects, the fuel cell system includes a metallic gasket disposed between the first side of the metallic flange and the metallic mounting surface of the component.

Yet another aspect of the disclosure provides a vehicle. The vehicle includes a fuel cell system. The fuel cell system includes a compressor that generates heat during operation of the fuel cell system. The compressor includes a metallic mounting surface. The fuel cell system also includes a duct assembly. The duct assembly includes a metallic flange having a first side, a second side opposite the first side, and an opening formed at the first side of the metallic flange. The first side of the metallic flange is joined to the metallic mounting surface of the compressor. The duct assembly also includes a plastic duct over-molded at the second side of the metallic flange. The plastic duct includes a passageway that is in fluid communication with the compressor via the opening of the metallic flange.

Implementations of this aspect of the disclosure may include one or more of the following optional features. In some examples, the second side of the metallic flange includes an interlock surface.

In some implementations, the vehicle further includes a bonding agent disposed between the second side of the metallic flange and the plastic duct.

In some examples, the plastic duct includes a flange portion extending along the second side of the metallic flange. The metallic flange includes a compression limiter extending from the second side of the metallic flange and at least partially through the flange portion of the plastic duct with a mechanical fastener extending through the metallic flange and the flange portion of the plastic duct and along the compression limiter. The mechanical fastener is received at the compressor to secure the duct assembly at the compressor.

In some aspects, the vehicle further includes a metallic gasket disposed between the first side of the metallic flange and the mounting surface of the compressor.

The details of one or more implementations of the disclosure are set forth in the accompanying drawings and the description below. Other aspects, features, and advantages will be apparent from the description and drawings, and from the claims.

### BRIEF DESCRIPTION OF THE DRAWINGS

The drawings described herein are for illustrative purposes only of selected configurations and are not intended to limit the scope of the present disclosure.

FIG. 1 is a perspective view of a duct assembly mounted to a vehicular component.

FIG. 2 is a cross-sectional view of the duct assembly and vehicular component of FIG. 1.

FIG. 3 is another cross-sectional view of the duct assembly and vehicular component of FIG. 1, including a temperature gradient representative of example temperatures experienced at the duct assembly and vehicular component during operation of the vehicular component.

FIG. 4 is a top-side view of a gasket disposed between a flange of the duct assembly and the vehicular component, including a temperature gradient representative of example temperatures experienced at the gasket during operation of the vehicular component.

FIG. 5 is a perspective view of the flange of the duct assembly.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising.” “including.” and “having.” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on.” “engaged to.” “connected to.” “attached to,” or “coupled to” another element or layer, it may be directly on, engaged, connected, attached, or coupled to the other element or layer, or intervening elements or layers may be present. In contrast, when an element is referred to as being “directly on.” “directly engaged to.” “directly connected to.” “directly attached to.” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first.” “second.” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app.” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory. Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICS (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

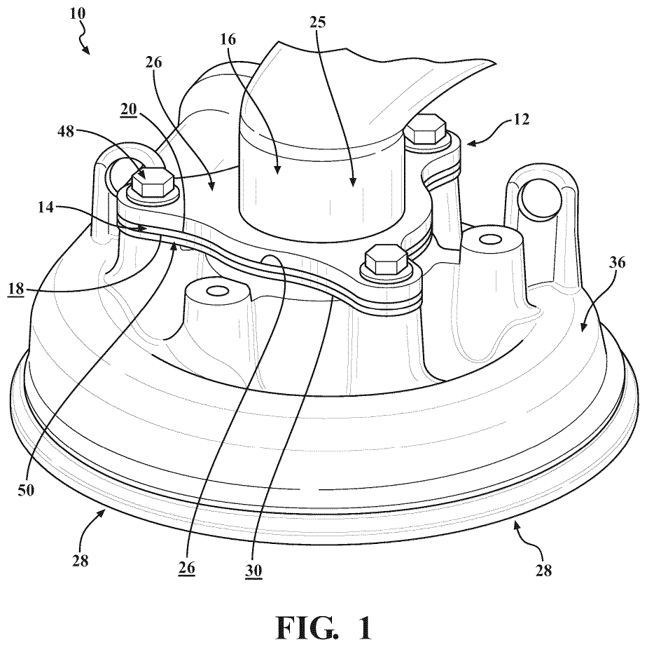

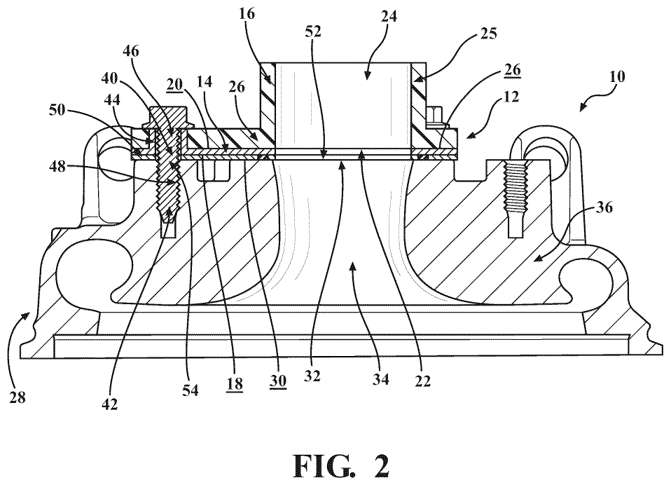

With reference to FIGS. 1 and 2, a vehicular system 10, such as a fuel cell system for powering a propulsion system of a vehicle (e.g., a passenger vehicle, a commercial vehicle, etc.), includes a duct assembly 12 that includes a metallic flange 14 and a plastic duct 16. As described further below, the duct assembly 12 is configured to transfer material (e.g., air, coolant, oil, etc.) to or from a component of the vehicular system 10 that generates heat during operation while resisting or at least partially shielding heat transfer from the heated component to the duct assembly 12. The duct 16 is formed from a plastic or rubber material (e.g., a thermoplastic material such as polyvinyl chloride (PVC), polycarbonate (PC), and acrylonitrile butadiene styrene (ABS)) having good flexibility and formability, so as to accommodate packaging constraints and reduce weight at the vehicular system 10. The metallic flange 14 is disposed at an interface between the duct assembly 12 and the component of the vehicular system 10 to at least partially shield the plastic duct 16 from the thermal output of the component. For example, the metallic flange 14 may be formed from machined steel or aluminum, or any suitable material configured to withstand temperatures at the component of the system 10 of up to 200 degrees Celsius or more, such as up to 450 degrees Celsius or more. Thus, incorporation of the metallic flange 14 into the plastic duct 16 allows the duct assembly 12 to accommodate packaging constraints while resisting thermal transfer from the vehicular component. Although described herein as relating to fuel cell systems, it should be understood that aspects of the duct assembly 12 may be suitable for use with any vehicular system exhausting or inletting material away from or to a heat generating component.

With continued reference to FIGS. 1 and 2, and also with reference to FIG. 5, the flange 14 includes a first side 18 and a second side 20 opposite the first side 18, where the first side 18 may include or provide a planar mounting surface. A flange opening 22 is formed at the first side 18 of the flange 14 and is in fluid communication with a duct passageway 24 that extends along a conduit body 25 of the duct 16. The conduit body 25 of the duct 16 extends from a base or flange portion 26 that is mated to the second side 20 of the flange 14.

When the duct assembly 12 is installed or mounted at the vehicular system 10, the first side 18 of the flange 14 is joined to or coupled to a vehicular component 28 of the system 10, such as a turbo compressor volute or similar component of a fuel cell system. Furthermore, the vehicular component 28 includes a planar mounting or top surface 30 formed from a metallic material, such as machined steel or aluminum. A component opening 32 is formed at the mounting surface 30 and is in fluid communication with a chamber or passageway 34 within a body 36 of the vehicular component 28. With the duct assembly 12 mounted to the vehicular component 28, the duct passageway 24 is in fluid communication with the chamber 34 of the vehicular component 28 via the opening 22 of the flange 14 and the opening 32 at the mounting surface 30 of the vehicular component 28. Thus, during operation of the system 10, the vehicular component 28 inlets or exhausts material via the duct assembly 12.

As shown in FIGS. 1 and 2, the flange portion 26 of the duct 16 extends perpendicularly from (and may at least partially surround or circumscribe) the conduit body 25. The flange portion 26 extends along the second side 20 of the flange 14. Furthermore, the flange portion 26 may include one or more mounting holes 40 that, when the duct assembly 12 is mounted at the vehicular component 28, align with corresponding fastener cavities or threaded receiving portions 42 of the vehicular component 28. At each mounting hole 40, the flange 14 includes a compression limiter 44. In other words, the flange 14 includes respective openings, through holes, or channels 46 aligned with the mounting holes 40 formed through the flange portion 26 of the duct 16. The compression limiters 44 at least partially circumscribe the channels 46 and extend from the second side 20 of the flange 14 and at least partially through the flange portion 26 of the duct 16. Each mounting hole 40, fastener cavity 42, and compression limiter channel 46 is configured to accept a mechanical fastener 48, such as a bolt or a screw. When the mechanical fastener 48 extends through the mounting hole 40 and along the channel 46 and is received at the fastener cavity 42, the mechanical fastener 48 fixedly mounts the duct assembly 12 to the vehicular component 28. As the mechanical fastener 48 is tightened to clamp the duct assembly 12 between the vehicular component and a head of the mechanical fastener 48, the clamping load is transferred through the compression limiter 44 to reduce compression and deformation of the plastic flange portion 26 of the duct 16. In this configuration, the compression limiter 44 is integrally formed with the flange 14 that interfaces with the vehicular component 28.

With continued reference to FIGS. 1 and 2, a metallic gasket 50, such as a single layer stainless steel (SLS) gasket or a multilayer stainless steel (MLS) gasket, is disposed between the first side 18 of the flange 14 (i.e., a metallic planar surface) and the mounting surface 30 of the vehicular component 28 (i.e., a metallic planar surface). With the duct assembly 12 mounted to the vehicular component 28, the gasket 50 is compressed between the flange 14 and the mounting surface 30 of the vehicular component 28 to form a sealed fluid connection between the duct passageway 24 and the chamber 34 of the vehicular component 28. The steel gasket 50 includes a center hole or opening 52 that, with the duct assembly 12 mounted to the vehicular component 28, may align with the opening 22 of the flange 14 and the opening 32 at the mounting surface 30, with the center hole 52 corresponding to the size of the opening 22 in the flange 14 and the component opening 32. Furthermore, the steel gasket 50 includes one or more fastener holes 54 configured to align with the corresponding mounting hole 40, fastener cavity 42, and compression limiter channel 46 and is configured to receive the mechanical fastener 48. When the mechanical fastener 48 is installed in the duct assembly 12 and the vehicular component 28, the compression limiter 44 of the flange 14 prevents the risk of the mechanical fastener 48 deforming or damaging the plastic duct 16. As the mechanical fastener 48 is tightened into the duct assembly 12 and the vehicular component 28, forcing the duct assembly 12 and vehicular component 28 into a greater level of compression with one another, the force of the mechanical fastener 48 will be applied to the compression limiter 44 as opposed to the duct 16. In doing so, the risk of damaging the duct 16 due to the installation of the mechanical fastener 48 is significantly reduced. Furthermore, the amount of compression force that may be applied on the duct assembly 12 and vehicular component 28 is increased, allowing the steel gasket 50 to form a tighter seal.

With continued reference to FIGS. 1 and 2, during formation of the duct assembly 12, a chemical bonding agent, such as an adhesive or primer, may be applied to the second side 20 of the metallic flange 14. After application of the bonding agent at the second side 20 of the flange 14, the plastic material of the duct 16 is overmolded onto the second side 20 of the flange 14. For example, the flange 14 may be placed into a mold and the plastic material may be injected into the mold at the second side 20 of the flange 14. The bonding agent improves adherence of the plastic material to the metallic flange 14 and improves durability of the duct assembly 12 over its life cycle.

Further, the second side 20 of the flange 14 may include an interlock surface, such as having one or more protrusions, ridges, crevices, dimples, and the like, to increase surface area connection between the plastic duct 16 and the flange 14. The one or more protrusions, ridges, crevices, dimples, and the like are schematically shown as being a series of alternating ridges (i.e., protrusions) and crevices 21 in FIG. 5. That is, when the plastic material of the duct 16 is overmolded onto the second side 20 of the flange 14, the plastic material may flow along and/or within the interlock surface and, when the plastic material cools and hardens, form a more secure attachment between the flange 14 and the duct 16. The secure attachment is achieved by increasing the contact area between the plastic material of the duct 16 and the flange 14, as providing the flange 14 with protrusions and crevices effectively increases the surface area of the flange 14 at the second side 20.

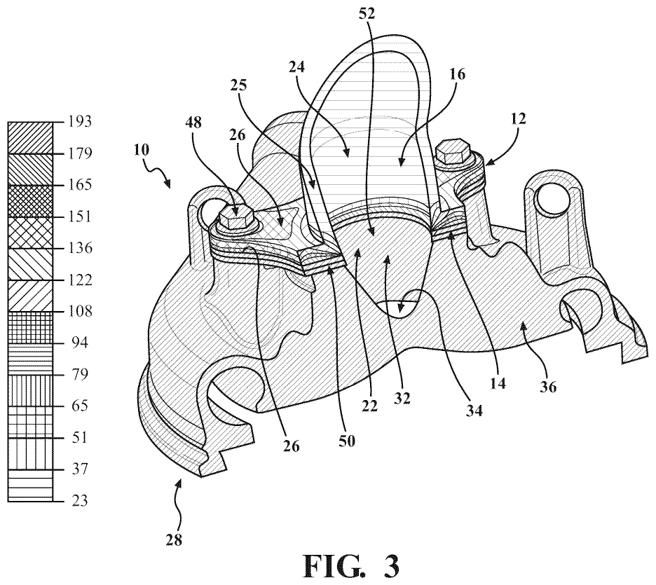

With reference now to FIGS. 1 and 3, the duct passageway 24 and the chamber 34 are fluidly sealed when the duct assembly 12 is installed at the vehicular component 28. In operation, the steel gasket 50) is compressed between the first side 18 of the flange 14 and the top surface 30 of the vehicular component 28. The first side 18 and the top surface 30 both being of a metallic planar surface allow for the steel gasket 50 to effectively create a fluidic seal between the duct assembly 12 and the vehicular component 28 when the mechanical fasteners 48 are installed, while use of a plastic duct 16 overmolded onto the metallic flange 14 allows for reduced weight and improved packaging of the vehicular system 10.

The incorporation of the steel gasket 50 and metallic flange 14 allows the duct assembly 12 to withstand high temperatures that may be present during operation of the vehicular system 10 while maintaining sealing durability requirements. That is, use of a steel gasket 50 between metallic mounting surfaces improves durability of the seal while reducing thermal exchange between the vehicular component 28 and the plastic duct 16. Furthermore, the steel gasket 50 is not prone to significant creep and deformation when exposed to high temperatures. When cold temperatures are present in the duct assembly, a seal is still maintained at the steel gasket 50. When the mechanical fasteners 48 are installed, the steel gasket 50 may be compressed to accommodate the sealing pressure requirements of the duct assembly 12 and the vehicular component 28 without experiencing deformation or other failure. The sealing pressure and durability of the steel gasket 50 is maintained between the duct assembly 12 and vehicular component 28 for transfer of gas and/or liquid between the duct assembly 12 and the vehicular component 28 via the duct passageway 24 and the chamber 34.

Continuing with the example of the vehicular component 28 being a compressor volute within a fuel cell system, during operation of the fuel cell system 10, ambient air flows into the duct passageway 24, passing through the component opening 32, and into the compressor 28. The compressor 28 generates heat during operation, and the heat may be thermally transferred to the flange 14 of the duct assembly 12. For example, heat generation may occur during operation of the compressor 28 to compresses the air received from the duct assembly 12. As the air is compressed, the air and compressor 28 are heated and engagement of the compressor 28 with the gasket 50 and/or the duct assembly 12 transfers heat toward the flange 14 and the gasket 50. Maintaining sealing pressure between the flange 14 and the compressor 28 during operation of the compressor 28 prevents air from escaping from between the duct assembly 12 and the compressor 28 as it travels from the duct passageway 24. As shown in FIG. 3, the steel gasket 50 and the metallic flange 14 act as a thermal shield between the compressor 28 and the duct 16. In the illustrated example, while the compressor 28 may reach temperatures exceeding 186 degrees Celsius during operation, the plastic duct 16 may stay at 23 degrees Celsius or less. High temperatures may risk damage to plastic components, such as the duct 16 and, thus, are dissipated or shielded from the duct 16 to increase longevity and prevent risks of failure. Properties of the steel gasket 50 and the metallic flange 14 between the vehicular component 28 and the duct 16, such as the metallic composition of the gasket 50 and the flange 14 or the thickness of the metallic flange 14, may be optimized to allow the gasket 50 and the flange 14 to act as thermal shields between the compressor 28 and the duct 16 and preclude heat transfer from the heated compressor 28. Because of this, the heat experienced by the duct 16 is significantly reduced compared to the heat present at the vehicular component 28 and the integrity of the seal between the gasket 50, the compressor 28 and the flange 14 is maintained.

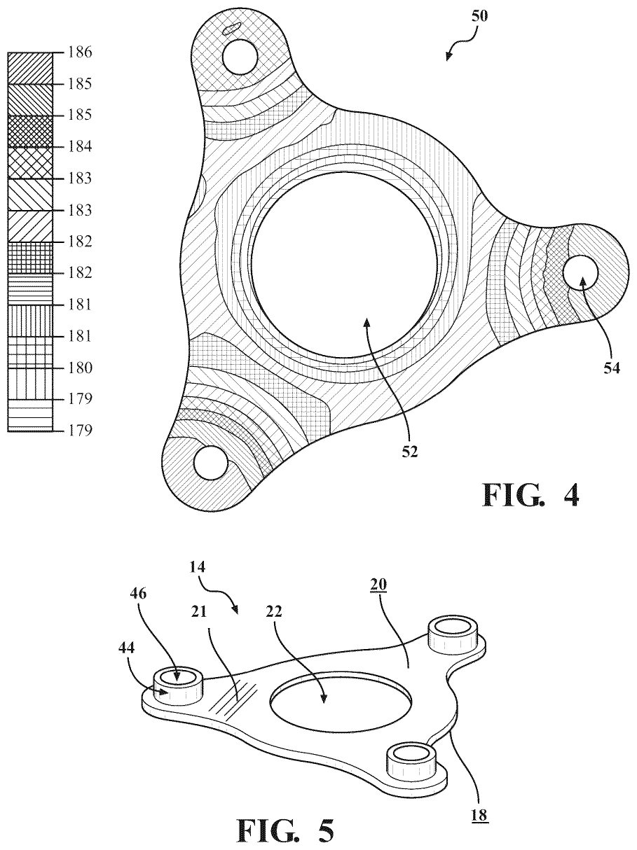

As shown in FIG. 4, during operation of the fuel cell system 10, the gasket 50 may attenuate thermal transfer between the vehicular component 28 and the flange 14. As shown, the temperature of the gasket 50 may be at its greatest at or near the fastener holes 54, due to the mechanical fasteners 48 being in direct contact with the heated vehicular component 28. Between the fastener holes 54 and the center hole 52, the temperature of the gasket 50 reduces until the lowest temperature is experienced at or near the center hole 52. Thus, exposure of the duct 16 to heat generated by the vehicular component 28 is reduced or prevented all-together. The metallic flange 14 and the steel gasket 50 act as thermal shields to prevent the plastic duct 16 from experiencing thermal transfer, preventing deformation and extending the lifespan of the duct 16 and, therefore, the entire duct assembly 12. The steel gasket 50 also allows for a significant amount of compression to be applied in forming the seal without failure and deformation of the gasket 50, allowing the duct assembly 12 to be applied to high heat and high pressure systems.

Over-molding the plastic duct 16 on the metallic flange 14, which may include use of a chemical and/or mechanical bonding agent such as adhesives and/or interlocks between the plastic duct 16 and the metallic flange 14, fixes the plastic duct 16 to the metallic flange 14 during manufacture of the duct assembly 12. A steel gasket 50 is disposed between the top surface 30 of the vehicular component 28 and the first side 18 of the metallic flange 14. The top surface 30 and the first side 18 are planar surfaces. Mechanical fasteners 48 connect the duct assembly 12 to the vehicular component 28, with the steel gasket 50 forming the seal between the chamber 34 of the vehicular component 28 and the duct passageway 24 of the duct 16. When sealed, pressurized and/or heated gas and/or liquid may travel between the vehicular component 28 and the duct 16 without escaping. The metallic flange 14 and the steel gasket 50 allow for the flange assembly 12 to be used in high pressure and high temperature environments without risking failure. Furthermore, the metallic flange 14 and the steel gasket 50 act as thermal shields between the vehicular component 28 and the duct 16, preventing the plastic material of the duct 16 from deforming or failing due to thermal transfer.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A duct assembly comprising:
a metallic flange having a first side, a second side opposite the first side, and an opening formed at the first side of the metallic flange; and
a plastic duct extending from the second side of the metallic flange, the plastic duct including a passageway that is in fluid communication with the opening of the metallic flange, the first side of the metallic flange configured to join to a metallic mounting surface of a vehicular component and the passageway of the plastic duct is configured to be in fluid communication with the vehicular component via the opening of the metallic flange when the duct assembly is mounted at the vehicular component.

2. The duct assembly of claim 1, wherein the plastic duct is over-molded at the second side of the metallic flange.

3. The duct assembly of claim 2, wherein the second side of the metallic flange comprises an interlock surface.

4. The duct assembly of claim 2, further comprising a bonding agent disposed between the second side of the metallic flange and the plastic duct.

5. The duct assembly of claim 1, wherein the duct assembly is configured to be secured at the vehicular component via a mechanical fastener extending through the metallic flange and received at the vehicular component.

6. The duct assembly of claim 5, wherein the plastic duct comprises a flange portion extending along the second side of the metallic flange, the mechanical fastener extending through the metallic flange and the flange portion of the duct.

7. The duct assembly of claim 6, wherein the metallic flange comprises a compression limiter extending from the second side of the metallic flange and at least partially through the flange portion of the plastic duct, the mechanical fastener extending through the metallic flange and the flange portion of the plastic duct and along the compression limiter.

8. The duct assembly of claim 1, wherein the first side of the metallic flange is configured to engage a metallic gasket disposed between the first side of the metallic flange and the mounting surface of the vehicular component.

9. The duct assembly of claim 1, wherein the metallic flange is configured to join to the metallic mounting surface at one selected from the group consisting of (i) an inlet of the vehicular component and (ii) an outlet of the vehicular component.

10. The duct assembly of claim 1, wherein the vehicular component comprises a compressor of a fuel cell system of a vehicle, the compressor generating heat during operation of the fuel cell system.

11. A fuel cell system comprising:
a component that generates heat during operation of the fuel cell system, the component comprising a metallic mounting surface; and
a duct assembly comprising:
a metallic flange having a first side, a second side opposite the first side, and an opening formed at the first side of the metallic flange, the first side of the metallic flange joined to the metallic mounting surface of the component; and
a plastic duct extending from the second side of the metallic flange, the plastic duct over-molded at the second side of the metallic flange and including a passageway that is in fluid communication with the opening of the metallic flange, the first side of the metallic flange configured to join to the metallic mounting surface of the component and the passageway of the plastic duct is configured to be in fluid communication with the component via the opening of the metallic flange when the duct assembly is mounted at the component.

12. The fuel cell system of claim 11, wherein the second side of the metallic flange comprises an interlock surface.

13. The fuel cell system of claim 11, further comprising a bonding agent disposed between the second side of the metallic flange and the plastic duct.

14. The fuel cell system of claim 11, wherein the plastic duct comprises a flange portion extending along the second side of the metallic flange, the metallic flange comprising a compression limiter extending from the second side of the metallic flange and at least partially through the flange portion of the plastic duct with a mechanical fastener extending through the metallic flange and the flange portion of the plastic duct and along the compression limiter, the mechanical fastener received at the component to secure the duct assembly at the component.

15. The fuel cell system of claim 11, further comprising a metallic gasket disposed between the first side of the metallic flange and the metallic mounting surface of the component.

16. A vehicle comprising:
a fuel cell system, the fuel cell system comprising:
a compressor that generates heat during operation of the fuel cell system, the compressor comprising a metallic mounting surface; and
a duct assembly comprising:
a metallic flange having a first side, a second side opposite the first side, and an opening formed at the first side of the metallic flange, the first side of the metallic flange joined to the metallic mounting surface of the compressor; and
a plastic duct extending from the second side of the metallic flange, the plastic duct over-molded at the second side of the metallic flange and including a passageway that is in fluid communication with the opening of the metallic flange, the first side of the metallic flange configured to join to the metallic mounting surface of the compressor and the passageway of the plastic duct is configured to be in fluid communication with the compressor via the opening of the metallic flange when the duct assembly is mounted at the compressor.

17. The vehicle of claim 16, wherein the second side of the metallic flange comprises an interlock surface.

18. The vehicle of claim 16, further comprising a bonding agent disposed between the second side of the metallic flange and the plastic duct.

19. The vehicle of claim 16, wherein the plastic duct comprises a flange portion extending along the second side of the metallic flange, the metallic flange comprising a compression limiter extending from the second side of the metallic flange and at least partially through the flange portion of the plastic duct with a mechanical fastener extending through the metallic flange and the flange portion of the plastic duct and along the compression limiter, the mechanical fastener received at the compressor to secure the duct assembly at the compressor.

20. The vehicle of claim 16, further comprising a metallic gasket disposed between the first side of the metallic flange and the mounting surface of the compressor.
